(19) United States
(12) Patent Application Publication
(10) Pub. No.: US 2007/0228012 A1
(43) Pub. Date: Oct. 4, 2007

(54) METHOD FOR MAKING A SATIN FINISH SURFACE

(75) Inventors: Francois Besson, Fiez (CH); Sylvain Boucard, Villers-le-lac (FR)

Correspondence Address: GRIFFIN & SZIPL, PC, SUITE PH-1, 2300 NINTH STREET, SOUTH, ARLINGTON, VA, 22204, US

(73) Assignee: COMADUR S.A., Le Locle (CH)

(21) Appl. No.: 11/690,378

(22) Filed: Mar. 23, 2007

(30) Foreign Application Priority Data
Mar. 28, 2006 (EP) 06111851.9

(51) Int. Cl. B23K 26/36; C23F 1/00; C03C 15/00

(52) U.S. Cl. 216/85; 219/121.69; 428/141; 216/89

(57) ABSTRACT

The invention concerns a method of making a satin finish surface on a part made of a material with a Vickers hardness greater than 1000 HV including at least one polished surface, mainly including the following steps: taking a support for the part and a pulse laser, capable of a relative movement with respect to each other in an XY plane, exposing the polished surface locally to a laser pulse with enough energy to cause local melting of the polished surface so as to form a micro-crater, repeating the laser pulses simultaneously with a relative movement of the piece relative to the laser, so as to traces micro-furrows on the polished surface, formed by the alignment of several successive partially overlapping micro-furrows, the micro-furrows being substantially parallel to each other and equidistant, and together defining the satin finish surface.

The invention relates to the field of microtechnology. It concerns more specifically a method of locally decorating a part made of a hard material. A “hard material” means materials with a Vickers hardness greater than 1000 HV.

Ceramics such as zirconia ZRO₂ or alumina Al₂O₃, and hard materials in general, are widely employed in watchmaking to make scratchproof cases and wristbands. The surface state of these parts is generally polished, which gives the part a shiny appearance. The mechanical satin finishing of such parts is awkward since, as they are very hard, they are difficult to machine. Moreover, such satin finishing does not allow patterns to be made, since the finish is applied to the entire surface.

The present invention proposes a method of satin finishing locally a part made of hard material, in particular of ceramics, allowing a pattern to be made on the surface.

More specifically, the invention concerns a method of achieving a satin finish surface on a part made of a hard material with a Vickers hardness greater than 1000 HV comprising at least one polished surface, mainly comprising the following steps:

taking a support for the part and a pulse laser, capable of a relative movement with respect to each other in an XY plane,

exposing the polished surface locally to a laser pulse with enough energy to cause local melting of the polished surface so as to form a micro-crater,

repeating the laser pulses simultaneously with a relative movement of the piece relative to the laser, so as to traces micro-furrows on the polished surface, formed by the alignment of several successive partially overlapping micro-furrows, the micro-furrows being substantially parallel to each other and equidistant, and together defining the satin finish surface.

The invention also concerns a part made of a material having a Vickers hardness greater than 1000 HV, comprising a polished surface with a local satin finish appearance due to the presence of substantially parallel and equidistant micro-furrows.

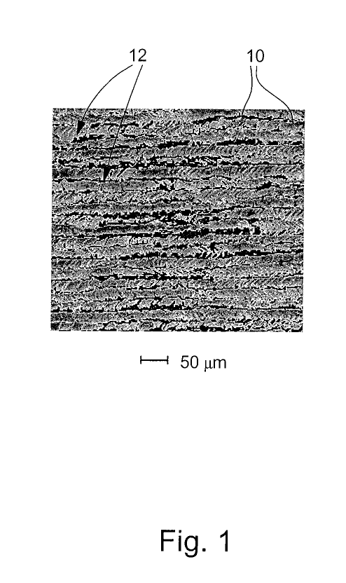

Other features will appear more clearly upon reading the following description of an example implementation of the method according to the invention, the description being made with reference to FIG. 1, annexed hereto, which is an enlargement showing the satin finish surface state of the part treated by the method according to the invention.

A part made of pigmented zirconia ZrO₂ is used for the method according to the invention. Pigmented zirconia means a zirconia oxide ZrO₂ doped with a yttrium oxide, calcium, magnesium or scandium, for stabilising the zirconia, and containing a metallic oxide. In a variant of the method, another ceramic or a cermet could be used, for example aluminium oxide Al₂O₃, titanium carbide TiC, or any other ceramic or cermet suited to manufacturing mechanical parts. The part is, for example, a watchcase or a bracelet link. It comprises at least one surface polished via a method well known to those skilled in the art.

The method according to the invention consists in locally illuminating the polished surface of the piece using a laser. In order to do this, the part is arranged on a support, on the path of a laser beam. The laser is moving in an XY plane and his movement is controlled by a computer. The laser is of the Nd:YAG pulse type, optically pumped, with a wavelength of 1.06 μm and an optical strength of 75 W. The laser is used in q-switched mode. The size of the spot is 100 μm, the pulse frequency is 20 to 40 kHz, and the pulse width is 11 μs. The scanning speed is of the order of 500 to 800 mm/s. A pattern is selected and converted, by suitable software, into a series of laser movement commands. The surface of the part is thus scanned by the laser beam to form the chosen pattern.

A photograph taken with a scanning electron microscope of the surface of the part thus treated is shown in FIG. 1. Via the effect of a laser pulse and provide enough energy is provided locally, the illuminated surface melts locally and a micro-crater 10 approximately 50 μm in diameter is formed. The succession of pulses combined with the movement of the laser, traces a substantially rectilinear micro-furrow 12 formed by the alignment of the partially overlapping successive micro-craters 10. It will be noted that at the centre of a micro-furrow 12, micro-craters 10 are substantially equidistant. Micro-furrows 12 are themselves substantially parallel to each other, substantially equidistant and partially superposed. They define together a surface of organised roughness on the microscopic scale. On the macroscopic scale, this surface has a particularly attractive satin finish, due to the presence of substantially parallel and equidistant microstructures. The contrast between the polished surface and the surface that is satin finished by laser forms the chosen pattern.

It should be noted that the present invention is not limited to the example implementation that has just been described, and that various simple alterations and variants can be envisaged by those skilled in the art, without departing from the scope of the invention defined by the annexed claims.

In particular, in the local satin finish method described, craters 10 are greatly superposed. In a variant of the method, they could be slightly superposed, while remaining aligned so as to form a micro-furrow 12. Moreover, the micro-furrows could be juxtaposed or even slightly distant from each other, while remaining substantially parallel and equidistant. The satin finish appearance would remain unchanged.

What is claimed is:

1. A method of making a satin finish surface on a part made of a material having a Vickers hardness greater than 1000 HV, including at least one polished surface, including mainly the following steps:
taking a support for said part and a pulse laser, capable of a relative movement with respect to each other in an XY plane,
exposing said polished surface locally to a pulse from said laser with enough energy to cause local melting of the polished surface so as to form a micro-crater,
repeating said laser pulses simultaneously with a relative movement of said piece with respect to said laser, so as to traces micro-furrows on said polished surface, formed by the alignment of several successive partially overlapping micro-furrows, the micro-furrows being substantially parallel to each other and equidistant, and together defining said satin finish surface.

2. The method according to claim 1, wherein the relative movement of said laser with respect to said piece is controlled such that said satin finish surface forms a pattern that contrasts with said polished surface.

3. The method according to claim 1, wherein said material is a ceramic material.

4. The method according to claim 3, wherein said ceramic material is a metallic oxide.

5. A part made of a material with a Vickers hardness greater than 1000 HV, including a polished surface locally exhibiting a satin finish due to the presence of micro-furrows that are substantially parallel to each other and equidistant.

6. The part according to claim 5, wherein said micro-furrows are formed by the alignment of partially overlapping and substantially equidistant micro-craters.
